(19) United States
(12) Patent Application Publication
(10) Pub. No.: US 2017/0043889 A1
(43) Pub. Date: Feb. 16, 2017

(54) Method for Extending the Shelf-Life of Crops Such as Roots, Tubers, or Bulbs

(71) Applicant: The United States of America, as Represented by the Secretary of Agriculture, Washington, DC (US)

(72) Inventors: Zhonglin T. Jin, North Wales, PA (US); Brendan A. Niemira, Oreland, PA (US)

(21) Appl. No.: 14/824,907

(22) Filed: Aug. 12, 2015

(51) Int. Cl. B65B 25/00; A01N 43/16; A01N 37/36; A23B 7/157; A01N 37/02; A23B 7/10; A23B 7/154; A01N 59/08; A01N 37/42

(52) U.S. Cl. CPC B65B 25/001; A01N 59/08; A01N 43/16; A01N 37/36; A01N 37/42; A01N 37/02; A23B 7/10; A23B 7/154; A23B 7/157; A23V 2002/00

(57) ABSTRACT

Methods for extending the shelf-life of crops (e.g., roots, tubers, bulbs, corms, rhizomes and similar commodities), involving washing the crops (e.g., ginseng roots) in an aqueous solution containing about 50 ppm to about 500 ppm sodium hypochlorite and subsequently coating the crops with an aqueous solution containing chitosan and at least one organic acid (e.g., lactic acid, levulinic acid, acetic acid), and placing the crops in modified atmospheric packaging. The shelf-life of crops can be extended by up to about 38 weeks.

### BACKGROUND OF THE INVENTION

Disclosed herein are methods for extending the shelf-life of crops (e.g., roots, tubers, or bulbs), involving washing the crops (e.g., ginseng roots) in an aqueous solution containing about 50 ppm to about 500 ppm sodium hypochlorite and subsequently coating the crops with an aqueous solution containing chitosan and at least one organic acid (e.g., lactic acid, levulinic acid, acetic acid), and then placing the crops in modified atmospheric packaging.

Ginseng is consumed world-wide as a dietary supplement and herbal medicine for thousands of years (Harkey, M. R., et al., Am. J. Clin. Nutr., 73: 1101-1106 (2001)). Asian ginseng (Panax ginseng), American ginseng (Panax quinquefolium), and notoginseng (Panax notoginseng) are the three most commonly used ginseng herbs in the world (Radad, K., et al., J. Pharmacol. Sci., 100: 175-186 (2006)). Asian ginseng roots have been used as medicinal material for over 2000 years in China, while American ginseng roots were first added to Chinese medicine in the early 18th century. Ginseng has been incorporated in health foods, such as ginseng candy and ginseng beverages for a long time (Ren, G., et al., Chemical components and physiological activities of a tonic beverage of American ginseng, Proceedings of the international ginseng conference-Vancouver 1994, Bailey, W. C., et al. (eds), pp. 169-172, 1995). Ginseng also has been widely used in Korea, Japan, Hong Kong, Canada, America, and many European countries (But, P. P. H., et al., The ginseng plant: processing and quality, Proceedings of the international ginseng conference-Vancouver 1994, eds. Bailey, W. C., et al. (eds), pp. 24-34, 1995). The worldwide annual production of fresh ginseng roots is about 20,000 tons, three quarters of which is Asian ginseng while the rest is American ginseng (Ference, D., et al., Korean J. Ginseng Sci., 15: 152-165 (1991)).

Ginseng is harvested exclusively in the autumn (Anonymous, Production Recommendations for Ginseng, Publication 610, Ministry of Agriculture, Food and Rural Affairs, Toronto, Canada (2009)). Fresh ginseng roots have much higher market value than dried roots. However, the local and international trade in American ginseng is almost exclusively as a dried product (Du, X. W., et al., Food Chemistry, 86: 155-159 (2004)). This is because fresh ginseng roots are very sensitive to the environment due to their high moisture content. Loss of color, flavor, or texture, and generation of off-flavors are common deteriorations that lower fresh root quality. Growth of microbes on the surface is the main cause of spoilage. Pathogenic contaminations on root surface would survive through transportation and storage and put consumers at risk. Current industry practices do not provide effective ways to extend the shelf-life of fresh ginseng roots. Microbial growth in fresh ginseng roots during 5 weeks of storage at 2° C. were reported (Jang, J. K., and K. H. Shim, Korean J. Ginseng Sci., 18(1): 60-65 (1994)). The only current practical storage condition is storage at 0-5° C. which results in less than 1 week shelf-life (Jeon, B. S., C. Y. and Lee, Journal of Food Science, 64(2): 328-331 (1999)). As ginseng trade is worldwide, longer shelf-life of fresh ginseng is critical for transportation and marketing. Jeon and Lee (1999) studied a combination of an antimicrobial rinse and modified atmosphere packaging (MAP) and extended fresh ginseng shelflife to a maximum of 3 months at 2° C. storage. To our knowledge, there is no report demonstrating fresh ginseng shelflife beyond 3 months. Therefore, the development of effective processing and packaging technologies for ginseng is very important to ensure its quality and value after longer storage times. Therefore, the objective of the present study is to extend the shelf-life of fresh ginseng to 6 months or longer using modified atmosphere packaging.

We used fresh ginseng as a model to develop methods to extend the shelf-life of postharvest fresh roots, tubers, bulbs, and derived products while maintaining important quality factors.

### SUMMARY OF THE INVENTION

Disclosed herein are methods for extending the shelf-life of crops (e.g., roots, tubers, or bulbs), involving washing the crops (e.g., ginseng roots) in an aqueous solution containing about 50 ppm to about 500 ppm sodium hypochlorite and subsequently coating the crops with an aqueous solution containing chitosan and at least one organic acid (e.g., lactic acid, levulinic acid, acetic acid), and then placing the crops in modified atmospheric packaging.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows fresh ginseng root samples before washing (left) and after washing (right) as described below.

FIG. 2 shows MAP package machine (left) and packaged samples (right) as described below.

FIG. 3 shows survivals of total bacteria (left) and yeasts and molds (right) on root samples after water washing and sanitizer washing as described below.

FIGS. 4A and B show microbial stability of roots after coating treated and stored in MAP for 38 weeks at 4° C. as described below. FIG. 4A shows total aerobic bacteria; FIG. 4B shows yeasts and Molds.

FIG. 5 shows weight loss of ginseng roots during storage at 4° C. as described below.

FIG. 6A shows a typical texture profile and FIG. 6B shows texture stability of roots during storage at 4° C. (B) as described below. The dot lines represent trends.

FIGS. 7A, B, and C show color stability of roots during storage at 4° C. as described below. FIG. 7A: whiteness (L*); Figure B: redness (a*); Figure C: yellowness (b*).

FIG. 8 shows root samples before packaging (0 day; top) and packaged with Air, 5% O₂, or 10% O₂ and stored at 4° C. for 2 weeks (middle) and 38 weeks (bottom) as described below.

FIG. 9A shows parsnip after washing and coating before packaging (A; top) and FIG. 9B shows total bacteria (TPC) and yeasts and molds (Y&M) on parsnip before and after storage for 74 days at 4° C. (B; bottom) as described below.

### DETAILED DESCRIPTION OF THE INVENTION

Disclosed herein are methods for extending the shelf-life of crops (e.g., roots, tubers, or bulbs), involving washing the crops (e.g., ginseng roots) in an aqueous solution containing about 50 ppm to about 500 ppm sodium hypochlorite and subsequently coating the crops with an aqueous solution containing chitosan and at least one organic acid, and then placing the crops in modified atmospheric packaging.

The sanitizer washing solution may be prepared using commercial sodium hypochlorite solution mixed with deionized water. The resulting washing solution generally contains about 50 ppm to about 500 ppm (e.g., 50 ppm to 500 ppm) sodium hypochlorite (preferably about 100 ppm to about 300 ppm (e.g., 100 ppm to 300 ppm), more preferably about 150 ppm to 250 ppm (e.g., 150 ppm to 250 ppm), most preferably about 200 ppm (e.g., 200 ppm)). Crops are washed in the washing solution with about 5 min agitation and rinsed with deionized water for about 3 times.

The edible coating solution may be prepared using chitosan and at least one organic acid (e.g., lactic acid, levulinic acid, acetic acid). The solution may contain about 0.5% to 2% (w/v) or higher concentration of chitosan and about 0.5% to about 2% (v/v) of organic acids; higher concentrations (e.g., up to about 5% v/v) of organic acids may be utilized provided the organic acids do not damage the crops. Any molecular weight chitosan (e.g., 50,000 to >375,000 Daltons) may be used, preferably low molecular weight (e.g., 50,000-190,000 Daltons). The organic acid may be selected from lactic acid, levulinic acid, acetic acid, citric acid, peracetic acid, fumaric acid, or any other organic acid that does not damage the crops. Each coating solution may be mixed overnight prior to performing coating treatments on food. Coating treatment may be applied onto crops by dipping the crops for about 1 minute in the coating solution and then drying at room temperature. The crops are then placed in modified atmospheric packaging (e.g., polynylon pouch; multiple layer aluminum pouch; or other gas-barrier pouch) filled with about 5 to about 20% O₂ or ambient air.

Crops treated by the methods described herein include roots, tubers, or bulbs, such as ginseng, as well as other vegetable bulbs, roots, corms, tubers, rhizomes and similar commodities intended for human consumption, such as carrots, chicory, garlic, ginger, horseradish, parsnip, radish, etc. The methods described herein may also be used to treat horticulturally valuable and useful bulbs, roots, corms, tubers, rhizomes and similar commodities, such as allium, amaryllis, crocus, daffodil, hyacinth, iris, lily, tulip, etc.

“Optional” or “optionally” means that the subsequently described event or circumstance may or may not occur, and that the description includes instances in which said event or circumstance occurs and instances where it does not. For example, the phrase “optionally comprising a defoaming agent” means that the composition may or may not contain a defoaming agent and that this description includes compositions that contain and do not contain a foaming agent.

By the term “effective amount” of a compound or property as provided herein is meant such amount as is capable of performing the function of the compound or property for which an effective amount is expressed. As will be pointed out below, the exact amount required will vary from process to process, depending on recognized variables such as the compounds employed and the processing conditions observed. Thus, it is not possible to specify an exact “effective amount.” However, an appropriate effective amount may be determined by one of ordinary skill in the art using only routine experimentation.

Unless defined otherwise, all technical and scientific terms used herein have the same meaning as commonly understood by one of ordinary skill in the art to which the invention belongs. As used herein, the term “about” refers to a quantity, level, value or amount that varies by as much as 30%, preferably by as much as 20%, and more preferably by as much as 10% to a reference quantity, level, value or amount. Although any methods and materials similar or equivalent to those described herein can be used in the practice or testing of the present invention, the preferred methods and materials are now described.

The following examples are intended only to further illustrate the invention and are not intended to limit the scope of the invention as defined by the claims.

### EXAMPLES

Preparation of ginseng samples and sanitizer washing: Freshly harvested 4-year-old American ginseng roots from Canada were used in this study (OGA Health LLC., Allentown, Pa.). Fresh ginseng roots were packed with soil and wet towel, shipped by express mail, and stored in a refrigerator at 4° C. and 60˜70% RH before the experimental study. All ginseng samples were washed with regular tap water and gently brushed to remove any adherent soil and then followed sanitizer washing.

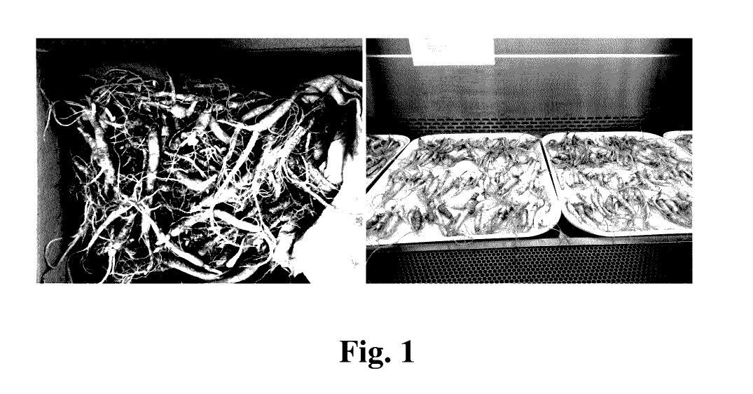

Sanitizer washing solution was prepared using 5 ml commercial sodium hypochlorite solution mixed with 1 liter of deionized water. The washing solution contained 200 ppm sodium hypochlorite. Root samples were washed in washing solution with 5 min agitation and rinsed with deionized water for 3 times. Washed roots were placed in a bio-safety cabinet at room temperature (22° C.) for 4 h to remove root surface moisture prior to coating treatments. FIG. 1 shows the fresh ginseng roots before and after washing.

Preparation of coating solution and treatment: Edible coating solution was prepared using lactic acid, levulinic acid, acetic acid solution and low molecular weight chitosan. The coating solution contained 0.5% (v/v) of each acid and 0.5% (w/v) of chitosan, as described by Jin and Gurtler (Jin, T., and J. B. Gurtler, Journal of Food Protection, 75 (8), 1368-1372 (2012)), where higher concentrations of chitosan and acids were used. Coating solutions were mixed overnight prior to performing coating treatments on samples. Coating treatment was applied onto each ginseng root by dipping samples for 1 minute in the coating solution as per the method of Guo et al. (Guo, M., et al., Food Control, 34: 24-30 (2013)). All treated samples were placed on a tray under bio-hood overnight to dry at room temperature.

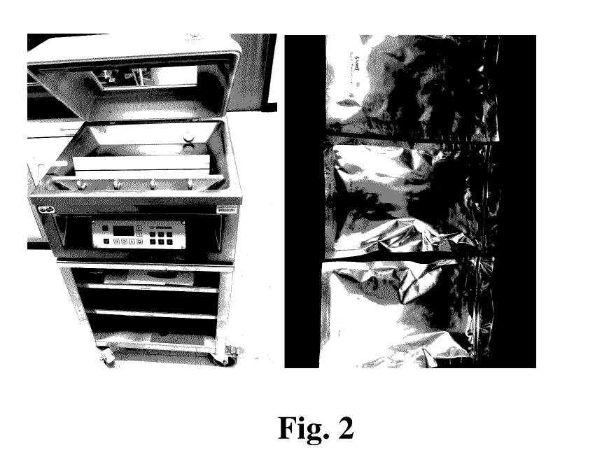

Modified atmosphere packaging and storage: Four pieces of treated ginseng root were placed in each foil bag (Royco Packaging Inc., Huntingdon Valley, Pa.) and were filled with a modified gas mixture containing 5% O₂/95% N₂, 10% O₂/90% N₂, or ambient air, respectively. The bags were flushed, gas-packed and sealed using a C200 Multivac machine (Multivac, Germany), as shown in FIG. 2. All samples were stored in a temperature/humidity-controlled chamber (Nor-Lake Inc. WI) at 4° C. and 60˜70% relative humidity. Two bags from each package condition were randomly selected and subjected to microbiological, texture, and color analyses every 14 days.

Determination of color values: Color values (L*, a*, and b*) of the ginseng samples were measured with Ultra Scan Vis Spectrocolorimeter (Hunter Associates Laboratory, Inc., Reston, Va.). Calibration was conducted with a white calibrated tile and a black light trap tile before sample measurement. A RSEX-Reflectance Specular Excluded mode type was applied to measure color values with port area view of 0.375 inches. L*(0=black, 100=white), a*(−a=greenness, +a=redness), and b*(−b=blueness, +b=yellowness) values were recorded. Five measurements for each piece, four pieces from each package condition were performed and results were averaged.

Determination of weight loss: Weight/moisture loss was determined using a pioneer balance (OHAUS Corp., Parsippany, N.J.). Each bag of ginseng samples was weighed approximately 90 minutes after leaving samples at room temperature and weights were recorded. Average of four bags at each sampling point was used for loss calculation. The weight/moisture loss is calculated as: Weight loss (%)=(initial weight−current weight)/initial weight×100.

Texture Analysis: Textures of ginseng samples were analyzed by a texture analyzer (Texture Technologies Corp., Scarsdale, N.Y.). A HDP/BSK blade set with knife was applied to detect the frangibility at room temperature under testing conditions with pre-test speed of 2.0 mm/s, test speed of 2.0 mm/s, post-test speed of 10.0 mm/s and rupture test distance of 1.0 mm. All texture analyzer settings were followed the instructions of operational manual and the results were shown as gram force/ginseng sample. Four pieces from each package condition were performed and results were averaged.

Microbiological analysis: Two pieces of ginseng root from each bag were placed into individual Whirl-Pak bag. Fifty ml of 0.1% peptone water was pipetted into each bag and both pieces of ginseng roots were hand massaged for two minutes. A serial dilution of each treatment was performed. A 1 ml of sample from each bag was diluted up to four times in 9 ml of 0.1% peptone water. One ml of each dilution was plated onto Plate Count Agar (PCA, BBL/Difco Laboratories, Sparks, Md.) plates for aerobic mesophilic bacterial populations and dichlorane rose bengal chloramphenicol agar (DRBC, Merck, Germany) plates for yeasts and molds. PCA plates were incubated at 35° C. for 2 days and DRBC plates were incubated at 22° C. for 5 days before colony forming units (CFU) were counted.

Statistical analysis: Data from experiments were analyzed using Analysis of Variance with SAS version 9.1 software (SAS Institute, Cary, N.C.). Bonferroni least significant difference test was used to determine the significant differences of mean values. Significance was defined at p<0.05.

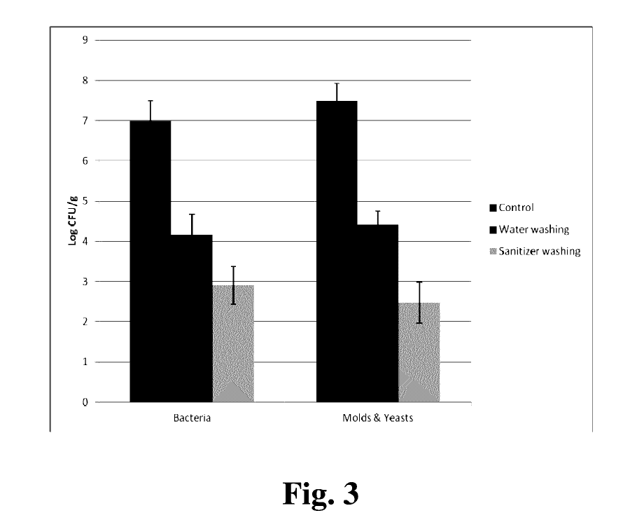

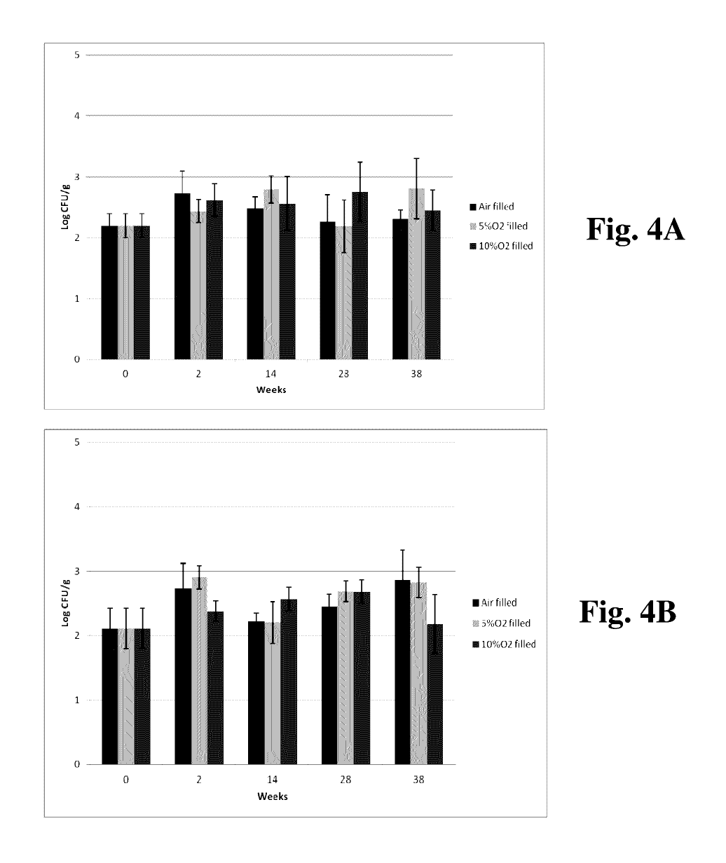

Results. Microbial reduction and stability during storage: Sanitizer washing was significantly more effective in reducing microbial loads on fresh roots than regular water washing (FIG. 3). Total bacteria were reduced from 7.0 log CFU to 4.2 log CFU by regular water washing and to 2.9 log CFU by sanitizer washing. Yeasts and molds were reduced from 7.5 log CFU to 4.3 log CFU by water washing and 2.5 log CFU by sanitizer washing. Coating treatment after sanitizer washing surprisingly further reduced bacteria and yeast and mold to log 2.2 log CFU and 2.1 log CFU respectively, as shown in samples at Day 0 in FIG. 4.

Surprisingly the microbial loads on roots were relatively stable during the storage period of 38 weeks, varying between 2.2 to 2.7 log CFU of total bacterial and between 2.1 to 2.9 log CFU of yeasts and molds (FIG. 4). There were no significant difference in microbial loads for all sanitizer washing and coating treated samples packed with Air, 5% O₂ or 10% O₂.

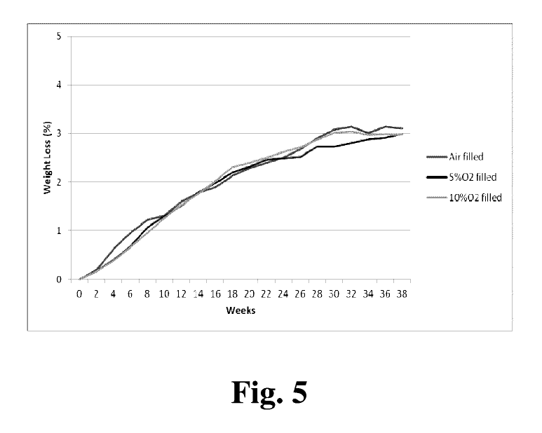

Weight loss during storage: Root weight losses during the course of storage for all samples were observed. The weight losses were surprisingly around 3.0% after 38 weeks at 4° C. (FIG. 5). There were no major differences in weight loss among all samples after 38 weeks.

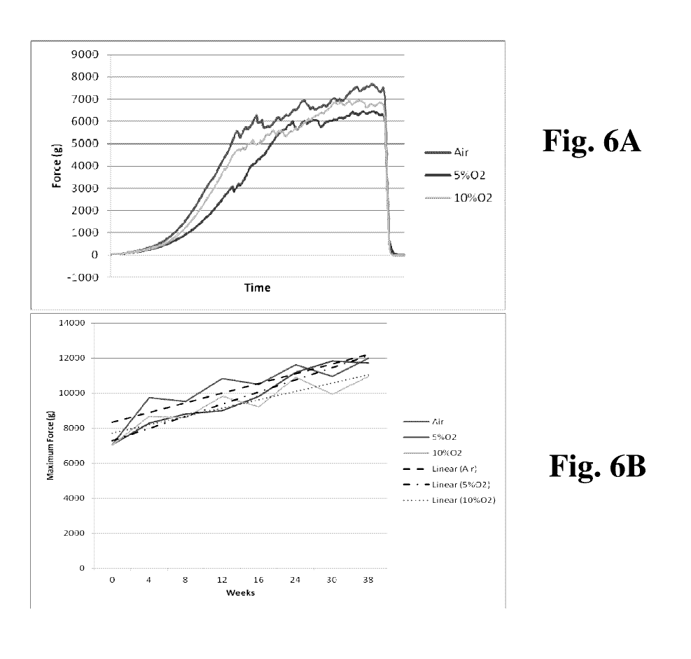

Texture Change during storage: FIG. 6A shows a typical profile from the texture analysis. Maximum force for cutting ginseng samples was used as an index of sample texture (hardness) change during storage (FIG. 6B). Although the harness values fluctuated, there existed a trend for a slight increase of hardness during the storage period which corresponds to the weight/moisture loss (FIG. 5). This explains that as the moisture/weight of root samples decreased, the hardness of root samples increased during the storage. There were no significant differences in texture among three package conditions (FIG. 6B),

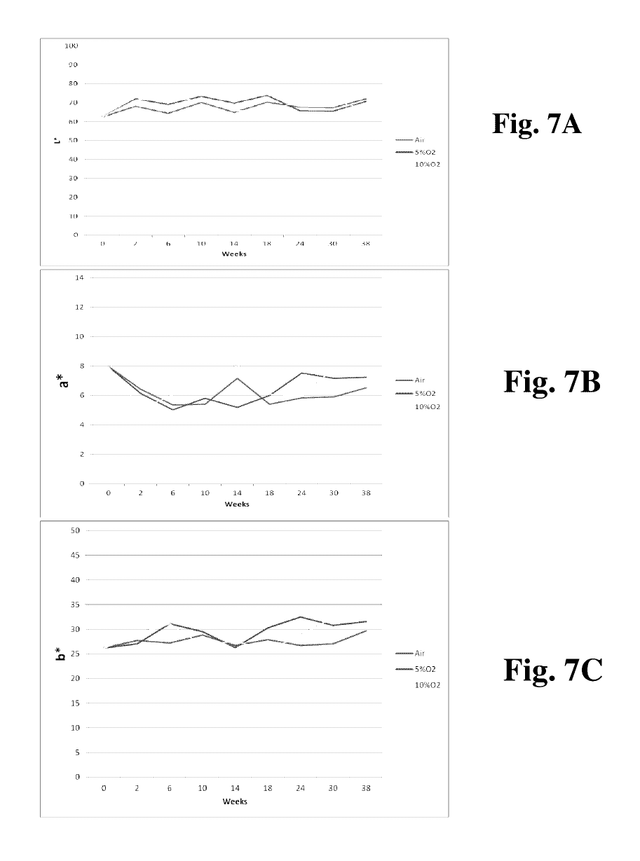

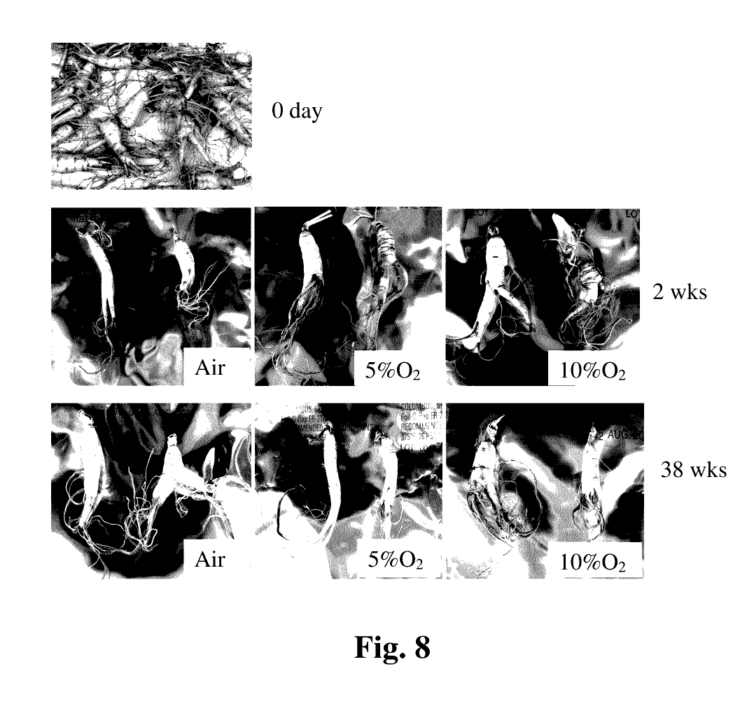

Color and appearance change during storage: Notable changes of color parameters (lightness, redness and yellowness) for each sample were surprisingly not observed during the storage for 38 weeks at 4 C (FIG. 7). L*values (lightness), a*values (redness), and b*values (yellowness) maintained around 70, 8, 30, respectively, throughout the whole storage period. There were no significant differences in color parameters among three package conditions (FIG. 7). The color stability during storage was further confirmed by sample appearance. FIG. 8 shows that root samples after 38 weeks of storage surprisingly had similar fresh appearance to those at 2 weeks and 0 day.

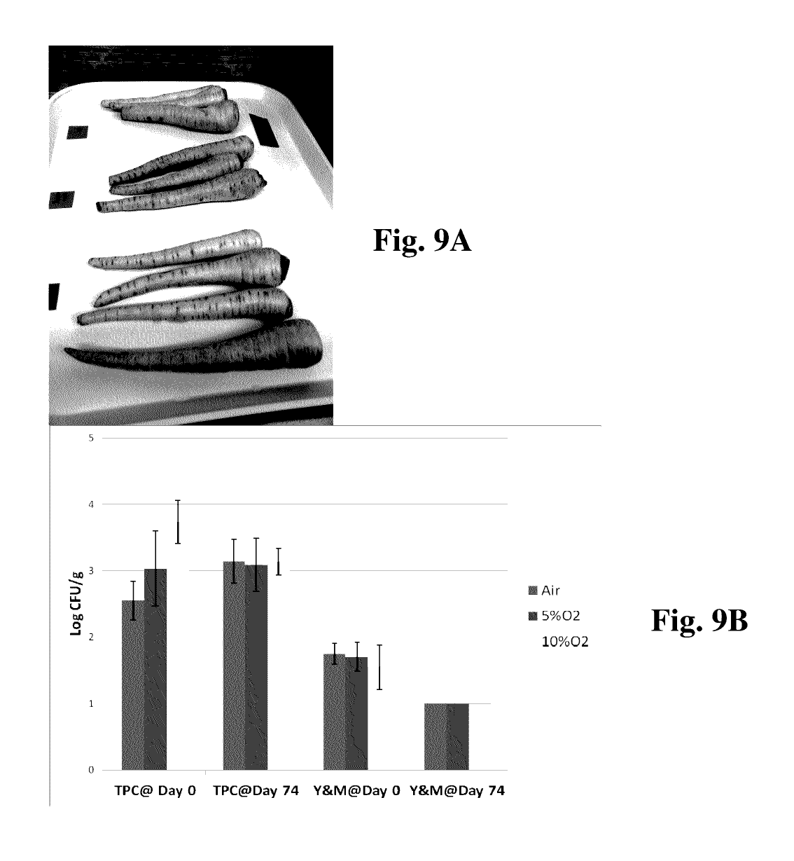

Storage stability of parsnip: The same sanitizer washing, coating, packaging, and storage conditions were applied to parsnip (FIG. 9A) to verify that the developed method is also suitable for other types of root and tuber crops. FIG. 9B shows that total bacteria were stable after 74 days of storage, and yeasts and molds reduced to nondetectable limit (<1 log CFU/g). Similar to ginseng roots, there were no significant differences in microbial loads on each sample after 74 days of storage. Notable loss in quality was not observed (data not shown).

Discussion: Postharvest storage of fresh ginseng roots has been a major concern of ginseng growers for many years. A wide seasonal variation in value is mainly due to the short shelf-life of fresh ginseng. Microbial contamination, dehydration, and physical and chemical changes accelerate deterioration of fresh ginseng roots. Therefore, development of a preservation technology with multiple functions that reduce microbial loads, present moisture loss, and preserve quality deterioration are urgently needed for ginseng growers and exporters. Surprisingly the combination treatments developed in this work effectively extended the shelf-life of fresh ginseng to approximately 9 months.

In our previous studies (data not shown), multiple non-thermal intervention treatments and packaging, alone or in combinations, were used to extend shelf-life of fresh ginseng roots. Fresh ginseng roots were treated by gamma irradiation, ultraviolet light, antimicrobial coatings, sanitizer washing, and packaged in vacuumed pouches or regular polyethylene terephthalate (PET) boxes. All treatments significantly reduced microbial loads on roots. However, gamma irradiations and ultraviolet light significantly impacted the quality of roots, resulting in browner color and softer texture as compared with other treatments. Vacuum packaging also negatively impacted the quality of roots. The combination of sanitizer washing, edible coating, and box packaging surprisingly extended the shelf-life of fresh ginseng roots to 6 months. However, the treated roots in boxes had higher weight/moisture loss rate (6.5-7.5%) than those in vacuumed pouches (4%) after 6 months of storage. In the present study, the weight loss was only 3.0% after 9 months due to different package containers, package materials and package methods: the previous study used PET box, and the current study used multiple layer aluminum pouch; the previous study used vacuum method, the current study used MAP method.

As ginseng roots come from soil, washing fresh produce prior to packaging is an important step in reducing microbial populations and maintaining microbial stability. Preliminary results showed vacuum packaging or MAP with 5% O₂, 10% O₂, or Air did not reduce the microbial load on roots. Hence, the method of washing used herein played a major role in reduction initial contaminated microorganisms on roots. Due to rough surface structure of ginseng roots and hairs, regular tap washing, even with a sanitizer, did not completely remove or inactivate microbial contaminants (FIG. 3). The remaining microbial contaminants on roots could grow during storage. Therefore, additional treatment, such as edible antimicrobial coating, was used after the sanitizer washing.

Edible antimicrobial coatings can be applied as a thin film on the surface of food, which reduces the exchanges of moisture, O₂, and CO₂ between food and the environment, and the antimicrobial activity from the coating inhibits the growth of spoilage and pathogenic microorganisms on food surface during transportation, storage and marketing. When applied properly, coatings can cover all parts of a heterogeneous product, such as ginseng roots with hairs. This approach is amenable to dipping or spraying. In the present study, chitosan in combination with multiple organic acids (acetic, lactic, and levulinic acids) was used. All ingredients in the coating solution are food grade, natural or recognized as safe for use in food application. Surprisingly the combination of multiple organic acids and chitosan significantly enhanced the antimicrobial activity of the coating compared to other studies using only one acid at a higher concentration. Azevedo et al. (Azevedo, A. N., Food Control, 43: 1-9 (2014)) reported that chitosan in a 1.5% acetic acid solution did not show antimicrobial property. In our previous studies (Chen, W., et al., International Journal of Food Microbiology, 155: 165-170 (2012); Jin and Gurtler, Journal of Food Protection, 75: 1368-1372 (2012)), coatings with 2% of acids were used to effectively extend shelf-life and reduce pathogens on cantaloupe and tomatoes. However, surprisingly that coating formulation did not show positive results for fresh ginseng roots. Higher acid concentrations (>1%) significantly impacted the root quality, resulting in softer texture and browner color during storage than those at lower acid concentrations (unpublished data). In this study, low concentrations (0.5% multiple acids and 0.5% chitosan) in the coating surprisingly showed significant positive impact. This formulation is unique for ginseng root preservation.

Controlled atmosphere (CA) or modified atmosphere (MA) storage techniques have been widely used for many years to extend the shelf-life of various fruits and vegetables, but very few have been reported for fresh ginseng. Jeon and Lee (Jeon, B. S., and C. Y. Lee, Journal of Food Science, 64(2): 328-331 1999) treated fresh American ginseng roots with an antimicrobial agent, and stored under 2, 5 or 8% CO₂ conditions at 2° C. storage, and found that only nearly 3 months of the shelf-life could be extended. Therefore, modified atmosphere with CO₂ could not effectively preserve ginseng quality for a long term. Other MAP with different gas composites are needed for fresh ginseng roots.

For fresh plant products, such as ginseng, consisting of living tissues with respiratory activity, coating and packaging should not fully deplete O₂ or lead to build-up of excessive CO₂ which may trigger physiologic deterioration, leading to anaerobic respiration and thus off-flavors, abnormal ripening, and spoilage. The O₂ levels that cause anaerobic reactions vary among commodities according to the permeability of the commodity peel, respiration patterns, storage temperature, as well as the type of coatings and packaging. As a general rule of thumb, a minimum of 1 to 3% O₂ is required around a commodity to avoid a shift from aerobic to anaerobic respiration (Arvanitoyannis, I, and L.G.M. Gorris, Edible and biodegradable polymeric materials for food packaging and coating, Chapter 21 IN Processing Foods—Quality optimization and process assessment, Edited by J. C. Oliveria, J. C. and F. A. R. Oliveria, CRC Press, 1999). For fresh ginseng roots, the coating and packaging conditions utilized in this study surprisingly allowed optimal oxygen levels to be maintained throughout storage. Therefore, the combination of chitosan coating and MAP with 5-20% O₂ minimized the quality changes due to O₂ depletion during storage. Quality and weight difference among the samples with 5% O₂, 10% O₂, or Air (ca. 20% O₂) were not observed (FIGS. 5-8), which suggests that the use of ambient air may be an economical approach for ginseng growers and exporters.

It is expected that our approach, developed for ginseng, will have broader applications for a variety of other fresh root and tuber-like crops. For example, similar results were surprisingly achieved for parsnip. The sanitizer washing and chitosan+acids coating treatments on reduction or inhibition of pathogens on roots are a subject of ongoing research. Based on the results with ginseng and other root and tuber commodities, it may be expected that similar effects could be achieved with bulbs, roots, tubers, corms, rhizomes and similar commodities intended for human consumption or for horticultural applications.

Thus this study demonstrated that the combination of sanitizer washing and chitosan-acids coating surprisingly provided effective antimicrobial functionality to keep microbial stability of fresh ginseng roots; and surprisingly coating and MAP with 5-20% O₂ effectively preserved the quality (texture, color, appearance) and prevented weight/moisture loss of fresh ginseng roots during storage. The unique coating formulation (chitosan and multiple organic acids) and the unique combination (sanitizer washing+coating+MAP) surprisingly made it possible for extending for at least 9 months the shelf-life of fresh ginseng roots.

All of the references cited herein, including U.S. Patents, are incorporated by reference in their entirety. Also incorporated by reference in their entirety are the following references: Betts, G., and L. Ever, Alternatives to hypochlorite washing systems for the decontamination of fresh fruit and Vegetables, IN: Improving the Safety of Fresh Fruit and Vegetables, Jongen W. (ed.), CRS Press, New York, pp. 351-372 (2005); Byun, M. W., et al., Radiat. Phys. Chem., 52: 95-99 (1998); Chen, W., et al., International Journal of Food Microbiology, 155: 165-170 (2012); Cheng, L., and P. D. Mitchell, Status of the Wisconsin ginseng industry, 2009; Court, W. E., 2000, Ginseng. The Genus Panax, Harwood Academic, Amsterdam; Doores, S., 1993, Organic Acids, IN “Antimicrobials in Foods”, P. M. Davidson and A. L. Branen (eds), 2^{nd}, Pp. 95-136, Marcel Dekker, New York; Doores, S., 2002, pH Control Agents and Acidulants, IN “Food Additives”, A. Branen et al. (eds), 2^{nd}, Pp. 621-660, Marcel Dekker, New York; Du, X. W., et al., Food Chemistry, 86: 155-159 (2004); Duke, James A., 1989, Ginseng: A Concise Handbook, Reference Publications, Inc., Michigan; Guo, M., et al., Journal of Food Science, 78: M1195-M1200 (2013a); Guo, M., et al., Journal of Food Control, 40: 64-70 (2013b); Guo, M., et al., Food Control, 34: 24-30 (2013c); Jin, T., et al., Journal of Food Protection, 76 (5): 779-785 (2013); Jin, T., and J. Gurtler, Journal of Applied Microbiology, 110: 704-712 (2011); Jin, T., and J. Gurtler, Journal of Food Protection, 75 (8): 1368-1372 (2012); Jin, T., and B. Niemira, Journal of Food Science, 76(3): M184-188 (2011); Kong, M., et al., International Journal of Food Microbiology, 144: 51-63 (2010); Lopez-Galvez, F., et al., Food Microbiology, 27: 199-204 (2010); Min. S., and J. M. Krochta, Antimicrobial films and coatings for fresh fruit and vegetables. Chapter 5, IN “Improving the safety of fresh fruit and vegetables”, W. Jongen (ed.), CRC, New York (2005); Morehouse, K. M., and Komolprasert, V, Irradiation of food and packaging: an overview, IN: V. Komolprasert, K. M. Morehouse (Eds.), Irradiation of Food and Packaging: Recent Developments, American Chemical Society, Boston, 2004, pp. 1-11; Olson, D. G., Food Technol., 52: 56-62 (1998); Reardon, J. T., and A. Sancar, Progress in Nucleic Acid Research and Molecular Biology, 79:183-235 (2005); Rico, D., et al., Trends in Food Science and Technology, 18: 373-386 (2007); Sanchez-Gonzalez, L., et al., Carbohydrate Polymers, 82: 277-283 (2010); Summers, C. H., et al., Journal of Food Safety, 30: 470-479 (2010); Vasconcelos, M. W., Frontiers in Plant Science, 5: 1-3 (2014); Yaun, B. R., et al., Int. J. Food Microbiol., 90: 1-82004 (2004); Ye, M., et al., International Journal of Food Microbiology, 127: 235-240 (2008); U.S. FDA, Irradiation in the production, processing, and handling of food, Final Rule. Fed. Reg. 65, 71056-71058 (2000); 21 CFR Part 178.

Thus, in view of the above, there is described (in part) the following:

A method for extending the shelf-life of crops, said method comprising (or consisting essentially of or consisting of) washing said crops in an aqueous solution containing about 50 ppm to about 500 ppm sodium hypochlorite and subsequently coating said crops with an aqueous solution comprising at least about 0.5% to about 2% (w/v) chitosan and about 0.5% to about 2% (v/v) of at least one organic acid and subsequently placing said crops in modified atmospheric packaging.

The above method, wherein said aqueous solution comprises about 0.5% to about 1.5% (w/v) chitosan. The above method, wherein said aqueous solution comprises about 0.5% to about 1% (w/v) chitosan.

The above method, wherein said aqueous solution comprises about 0.5% to about 1.5% (v/v) of least one organic acid. The above method, wherein said aqueous solution comprises about 0.5% to about 1% (v/v) of at least one organic acid.

The above method, wherein said at least one organic acid is selected from the group consisting of lactic acid, levulinic acid, acetic acid, and mixtures thereof.

The above method, wherein said modified atmospheric packaging comprises multiple layer aluminum pouch or other containers with gas-barrier materials and atmospheres.

The above method, wherein the shelf-life of crops is extended about 9 months (e.g., 9 months).

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

1. A method for extending the shelf-life of crops, said method comprising washing said crops in an aqueous solution containing about 50 ppm to about 500 ppm sodium hypochlorite and subsequently coating said crops with an aqueous solution comprising at least about 0.5% to about 2% (w/v) chitosan and about 0.5% to about 2% (v/v) of at least one organic acid and subsequently placing said crops in modified atmospheric packaging; wherein said at least one organic acid is selected from the group consisting of lactic acid, levulinic acid, acetic acid, and mixtures thereof; wherein the shelf-life of said crops is about 9 months after washing said crops in an aqueous solution containing about 50 ppm to about 500 ppm sodium hypochlorite and subsequently coating said crops with an aqueous solution comprising at least about 0.5% to about 2% (w/v) chitosan and about 0.5% to about 2% (v/v) of at least one organic acid and subsequently placing said crops in modified atmospheric packaging; and wherein said crops are roots, tubers, or bulbs.

2. The method according to claim 1, wherein said aqueous solution comprises about 0.5% to about 1.5% (w/v) chitosan.

3. The method according to claim 1, wherein said aqueous solution comprises about 0.5% to about 1% (w/v) chitosan.

4. The method according to claim 1, wherein said aqueous solution comprises about 0.5% to about 1.5% (v/v) of least one organic acid.

5. The method according to claim 1, wherein said aqueous solution comprises about 0.5% to about 1% (v/v) of at least one organic acid.

6. (canceled)

7. The method according to claim 1, wherein said modified a nospheric packaging comprises multiple layer aluminum pouch or other containers with gas-barrier materials and atmospheres.

8. (canceled)

9. The method according to claim 1, wherein said crops are ginseng roots.
